(19) United States
(12) Patent Application Publication
(10) Pub. No.: US 2005/0223859 A1
(43) Pub. Date: Oct. 13, 2005

(54) Handheld die cutting machine

(76) Inventors: David B. Larsen, Highland, UT (US); Consuelo N. Larsen, Highland, UT (US)

Correspondence Address: C.A.D. DESIGN, LLC, 1035 E. DODGE STREET, FREMONT, NE, 68025, US

(21) Appl. No.: 10/858,560

(22) Filed: Jun. 1, 2004

Related U.S. Application Data
(60) Provisional application No. 60/560,843, filed on Apr. 8, 2004.

(51) Int. Cl. B26D 1/00

(52) U.S. Cl. 83/13; 83/436.9

(57) ABSTRACT

A die cutting machine includes a body and first roller supported for rotation relative to the body. A second roller is supported for rotation relative to the body at a position spaced from the first roller. The first and second rollers define a feed space therebetween sized to accommodate a die assembly. The die cutting machine is configured to be supportable on a surface and moveable along the surface. The first roller is configured to rotate in response to movement of the die cutting machine along the surface. In one arrangement, the second roller may be configured to rotate along with rotation of the first roller. Furthermore, the first roller may be manually rotatable without movement of the die cutting machine along a surface. Also disclosed is a method of cutting or embossing with the disclosed die cutting machine.

### RELATED APPLICATION

This application claims priority from U.S. Provisional Patent Application No. 60/560,843, filed Apr. 8, 2004, the entirety of which is incorporated by reference herein and made a part of this specification.

### BACKGROUND OF THE INVENTION

1. Field of the Invention

The present invention relates generally to die cutting machines and, more specifically, to a handheld die cutting machine.

2. Description of the Related Art

Die cutting machines are often employed in an educational or arts & crafts setting to permit a material to be cut into an intricate shape more quickly and with more precision than is possible with other means of cutting a material, such as scissors for example. Die cutting machines may also permit embossing of materials, in addition to cutting. One type of die cutting machine is configured to pass a cutting die (or embossing die) assembly between a pair of compression surfaces which compress the die assembly to cut the workpiece. A typical die assembly may include a base plate, a cutting die, and a cover plate, stacked on top of one another. A workpiece (e.g., a sheet of paper or other material to be cut or embossed) is typically placed adjacent the die. The die includes a sharpened cutting surface tracing the perimeter of a desired shape, such as a letter or number, for example. As the die assembly is passed between the compression surfaces, it is compressed such that the cutting surface of the die cuts through the one or more workpieces in the die assembly to produce the desired shape.

Die cutting machines are available in variety of sizes to suit different applications. For example, commercial die cutting machines may be configured to accommodate multiple workpiece layers within a die assembly and may be configured to accept die assemblies having relatively large dimensions. Consumer oriented die cutting machines, such as those used in an educational or arts & crafts setting, are typically smaller in scale and may be only able to cut a few workpiece layers (or only one layer) at one time.

One type of consumer oriented die cutting machine is essentially a scaled-down version of a commercial machine. Such a machine typically includes a base, which supports a pair of opposing compression surfaces. Typically, one of the compression surfaces is defined by a roller and the other compression surface is defined by either a roller or a translating table. One of the roller or table is driven by a motor or hand-operated crank. A die assembly is passed between the compression surfaces to cut (or emboss) the workpiece. The size of a die assembly that may be accommodated by the die cutting machine is practically limited by the width of the roller (or table), thus, die assemblies having a relatively large lengthwise dimension may be accommodated by such a die cutting machine. However, such a die cutting machine is still relatively expensive and less than ideal for transporting from place to place.

Another type of consumer oriented die cutting machine includes a pair of pressure plates configured to receive a die assembly therebetween. A hand-operable actuation mechanism is configured to move the pressure plates toward one another to apply a squeezing force to the die assembly. However, the size of die assembly that can be accommodated with such a die cutting machine is limited by the size of the pressure plates. In addition, because the machine develops the cutting force via a hand-operated mechanism, much like a single hole punch, repeated use may lead to discomfort for the user.

### SUMMARY OF THE INVENTION

Preferred embodiments of the present die cutting machine have relatively small dimensions to be easily transportable and are relatively inexpensive compared to other consumer oriented and commercial machines, while still providing satisfactory cutting performance. In one arrangement, the die cutting machine is sized and shaped to permit a user to grasp the machine by hand and move it along a surface, such as a table top or countertop, for example. Movement of the device along a surface imparts rotational motion upon one or more drive wheels of the device which, in turn, cause rotation of upper and/or lower rollers. The rollers are spaced from one another a sufficient distance to accept a die assembly therebetween and impart a compressive force on the die assembly as it is passed between the rollers. Preferably, the die cutting machine is also provided with a knob or handle to permit manual rotation of the drive wheel, or drive wheels, without requiring the device to be moved along a surface.

One aspect of a preferred embodiment involves a die cutting device including a housing and a pair of frame members supported within the housing in a spaced apart orientation. A first roller is rotatably supported at opposing end portions by the pair of frame members. At least one drive wheel is coupled to the first roller and includes a portion exposed from the housing such that the at least one drive wheel is capable of rolling along a surface to thereby rotate the first roller. A second roller is spaced from the first roller to define a feed space with the first roller. The feed space is configured to accommodate a die assembly. A transmission mechanism is configured to rotate the second roller in response to rotation of the first roller.

Another aspect of a preferred embodiment involves a die cutting device including a body and a first roller supported for rotation relative to the body. A second roller is supported for rotation relative to the body at a position spaced from the first roller. The first and second rollers define a feed space sized to accommodate a die assembly. The device is configured to be supportable on a surface and moveable along the surface. The first roller is configured to rotate in response to movement of the device along the surface.

Yet another aspect of a preferred embodiment involves a die cutting device including a first compression surface and a second compression surface spaced from the first compression surface. The first and second compression surfaces define a feed space sized to accommodate a die assembly. The device additionally includes means for moving a die assembly through the feed space in response to movement of the device along a surface.

A preferred method of die cutting includes the step of rotating a first roller by moving a die cutting device along a surface. The method also includes feeding a die assembly through a feed space defined between the first roller and the second roller. The method further includes compressing the die between the first and second rollers.

### BRIEF DESCRIPTION OF THE DRAWINGS

These and other features, aspects and advantages of the present invention are described with reference to drawings of preferred embodiments, which are intended to illustrate, but not to limit, the present invention. The drawings contain seven figures.

FIG. 1 is a side view of a die cutting machine including certain features, aspects and advantages of the present invention.

FIG. 2 is a side view of the die cutting machine of FIG. 1 illustrating certain internal components of the machine, such as a drive wheel, upper and lower rollers, and upper and lower gears. The drive wheel, upper and lower rollers, and an outer housing of the die cutting machine are drawn in phantom.

FIG. 3 is a perspective view of one-half of the outer housing of the die cutting machine of FIG. 1.

FIG. 4 is a partial, sectional front view of the die cutting machine of FIG. 1 illustrating a pair of spaced apart frame members supporting the upper and lower rollers.

FIG. 5 is a side view of one of the Pair of the frame members of FIG. 4.

FIG. 6 is a perspective view of a modification of the die cutting machine of FIGS. 1-5.

FIG. 7 is still another modification of the die cutting machine of FIGS. 1-5.

### DETAILED DESCRIPTION OF THE PREFERRED EMBODIMENTS

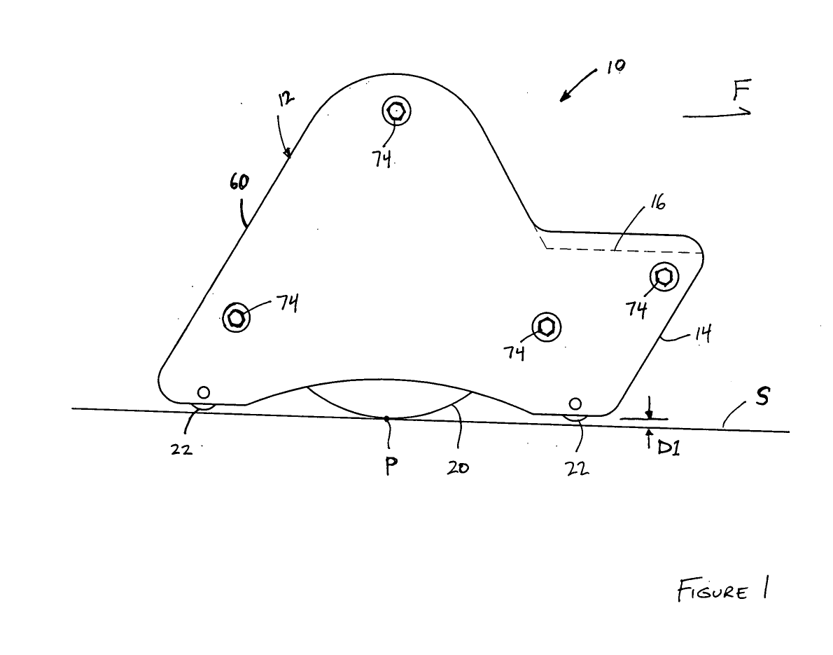

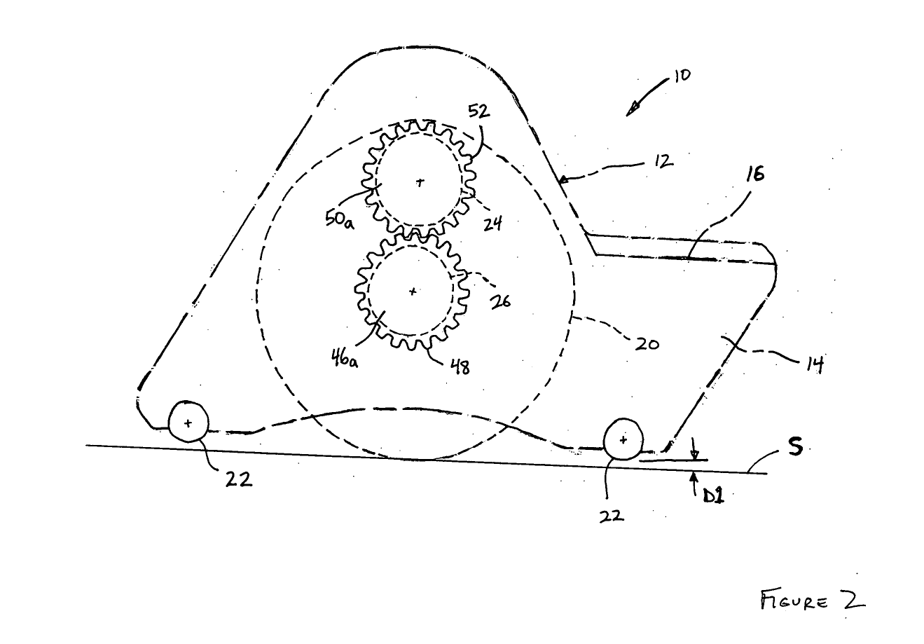

FIGS. 1-5 illustrate a preferred die cutting machine, indicated generally by the reference numeral 10. The illustrated die cutting machine 10 is configured to operate with existing cutting dies or embossing dies manufactured by a number of different entities primarily for use in an educational or crafts setting. Furthermore, dies manufactured specifically for the illustrated die cutting machine 10 may be used as well. As will be appreciated by one of skill in the art, the machine 10 may be configured for use with other systems that utilize the application of a compressive force to an object. As used herein, “die cutting machine” also encompasses embossing machines or other apparent uses of the disclosed device.

The die cutting machine 10 has a body including a housing 12. The housing 12 is configured to permit the die cutting machine 10 to be grasped by the hand of a user and moved along a surface S. The illustrated housing 12 has a generally triangular-shaped side profile, with the exception of a platform supporting portion 14 that extends from a lower forward end of the housing 12. The platform supporting portion 14 defines a platform 16, which is configured to receive a die assembly after the die assembly has passed through the die cutting machine 10, as is described in greater detail below. Advantageously, the illustrated shape of the housing 12 permits a user to easily grasp the machine 10 to move it along the surface S. Although the housing 12 may take on a variety of shapes and sizes, preferably, the housing 12 is configured to permit it to be conveniently grasped and moved by a user.

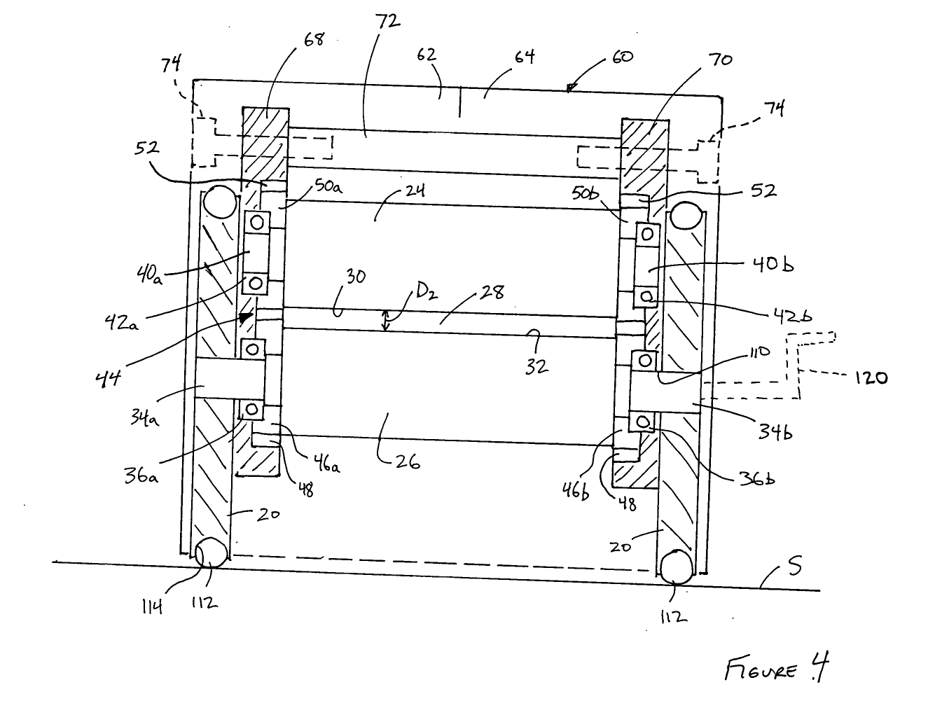

The die cutting machine 10 includes at least one and, preferably, a pair of drive wheels 20 (both drive wheels 20 are shown in FIG. 4). A portion of the drive wheels 20 extend from the housing 12 to contact the surface S and rotate as the die cutting machine 10 is rolled along the surface S in a forward direction (indicated by the arrow F). Rotation of the drive wheels 20 is utilized to convey a die assembly through the die cutting machine 10, as is described in greater detail below. Further, movement of the die cutting machine 10 along the surface S in a direction opposite of the direction F is also possible to convey the die assembly through the machine 10 in an opposite direction to that described below.

Preferably, the housing 12 also supports a pair of idler wheels 22. In the illustrated arrangement, one idler wheel 22 is positioned forwardly of the drive wheel 20 and the other idler wheel 22 is positioned rearwardly of the drive wheel 20. Desirably, the idler wheels 22 are spaced above the surface S a distance D1 when the housing 12 is oriented horizontally and the drive wheels 20 are resting on a relatively flat surface S. Accordingly, the die cutting machine 10 may be pivoted about a contact point P of the drive wheels 20 to rest on the drive wheels 20 and one set of the forward or rearward idler wheels 22. Such an arrangement provides stability to the movement of the die cutting machine 10, while permitting the drive wheels 20 to remain engaged with the surface S and also reducing the likelihood of the housing 12 from contacting the surface S.

The idler wheels 22 may be of any suitable arrangement to perform the above-described function. For example, the idler wheels 22 may be elongate, cylindrical members extending generally the entire width of the housing 12. Alternatively, smaller idler wheels 22 may be provided at or near each corner of the housing 12 for a total of four or more idler wheels 22 (that is, a pair of idler wheels 22 forward of the drive wheels 20 and a pair of idler wheels 22 rearward of the drive wheels 20). The idler wheels 22 may also be in the form of roller bearings, spherical rollers, or other suitable mechanisms. Furthermore, the idler wheels 22 may be replaced, or supplemented with, non-rotating contact surfaces, or bumpers. In other arrangements, idler wheels 22 (or similar alternative features) may not be necessary or desired.

Preferably, the die cutting machine 10 includes an upper roller 24 and a lower roller 26, which cooperates to define a feed space 28 therebetween. Desirably, each roller 24, 26 is substantially cylindrical in shape and defines an axis that is arranged substantially parallel with the surface S. However, the rollers 24, 26 may be crowned, such that a center portion of the roller 24 or 26 has a larger diameter than the diameter of the end portions of the roller 24 or 26. Such an arrangement may assist in centering the die assembly as it moves through the feed space 28 and/or apply a more uniform pressure to the die assembly, as will be appreciated by one of skill in the art.

The upper roller 24 defines an external compression surface 30 and the lower roller 26 defines an external compression surface 32. The compression surfaces 30, 32 define a distance D2 therebetween at their closest point (along an imaginary line connecting the axes of the rollers 24, 26). The distance D2 is sized such that the feed space 28 may accommodate a die assembly and, preferably, is sized to apply a compressive force to a die assembly, as will be appreciated by one of skill in the art.

In the illustrated arrangement, the lower roller 26 is coupled for rotation with the drive wheels 20. Accordingly, rotation of the drive wheels 20 as a result of moving the die cutting machine 10 along the surface S also results in rotation of the lower roller 26. Rotation of the lower roller 26 provides a motive force tending to convey or pull a die assembly through the feed space 28. Rotation of the lower roller 26 may provide the sole motive force for propelling the die assembly, or the rotation of the lower roller 26 may assist another mechanism for moving the die assembly. As will be appreciated by one of skill in the art, the upper roller 24 may be configured to rotate along with rotation of the drive wheels 20 or other rotation-inducing mechanism, in addition or alternative to the lower roller 26.

Preferably, the lower roller 26 includes a pair of shaft portions 34a, 34b extending from opposing ends of the intermediate portion of the roller 26. The shaft portions 34a, 34b are fixed for rotation with, the drive wheels 20 and, preferably, provide support for the drive wheels 20. A pair of bearings 36a, 36b support the lower roller 26 for rotation relative to the housing 12 of the die cutting machine 10. Specifically, the bearing 36a supports the shaft portion 34a and the bearing 36b supports the shaft portion 34b. The bearings 36a, 36b may be of any suitable structure, such as a bushing or roller bearing, for example. In addition, other suitable means for permitting relative rotation between the lower shaft 26 and the housing 12 may be employed.

Preferably, the upper roller 24 is constructed and arranged in a similar manner to the lower roller 26. Accordingly, the illustrated upper roller 24 includes an opposing pair of shaft portions 40a, 40b extending from an intermediate portion of the roller 24. The shaft portions 40a, 40b are supported for rotation relative to the housing 12 by a pair of bearings 42a, 42b, respectively. Alternatively, other means of permitting relative rotation between the upper roller 24 and the housing 12 of the die cutting machine 10 may also be employed.

Although the upper roller 24 may be freely rotatable relative to the housing 12, preferably, the upper roller 24 is fixed for rotation with the lower roller 26 by a transmission mechanism 44. In the illustrated arrangement, the transmission mechanism 44 is in the form of a gear set. However, other suitable means for transmitting motion from the lower roller 26 to the upper roller 24 may also be employed, such as chain drive or belt drive, for example. Furthermore, in an alternative arrangement, the upper roller 24 may be directly driven by the drive wheels 20.

Preferably, a pair of gears 46a, 46b are coupled to the lower roller 26. In the illustrated arrangement, the gears 46a, 46b are positioned between the shaft portions 34a, 34b, respectively, and the intermediate portion of the roller 26. Thus, the gears 46a, 46b straddle an intermediate portion of the roller 26. The gears 46a, 46b are fixed for rotation with the shafts 34a, 34b and the roller 26. The gears 46a, 46b define a plurality of gear teeth 48 on their outer perimeter.

Similarly, the upper roller 24 includes a pair of gears 50a, 50b between the respective shaft portions 40a, 40b and the intermediate portion of the roller 24. The gears 50a, 50b are fixed for rotation with the roller 24 and include gear teeth 52 about their outer periphery. Although gears 46a,b and 50a,b are provided on both ends of the rollers 24, 26 in the illustrated die cutting machine 10, other arrangements are possible wherein gears are only provided on one side of the rollers 24, 26.

The gear teeth 48 of the gears 46a, 46b engage the gear teeth 52 of the gears 50a, 50b to rotate the upper roller 24 along with rotation of the lower roller 26. Preferably, the gears 46a, 46b and 50a, 50b include an equal number of gear teeth 48, 52 such that the upper roller 24 rotates at the same speed as the lower roller 26. By configuring the upper roller 24 for positive rotation along with the lower roller 26, the die assembly is conveyed through the feed space 28 with a velocity of an equal magnitude at both the upper and lower surfaces of the die assembly. Advantageously, such an arrangement inhibits shifting of individual components of the die assembly to achieve a precise cut (or embossment).

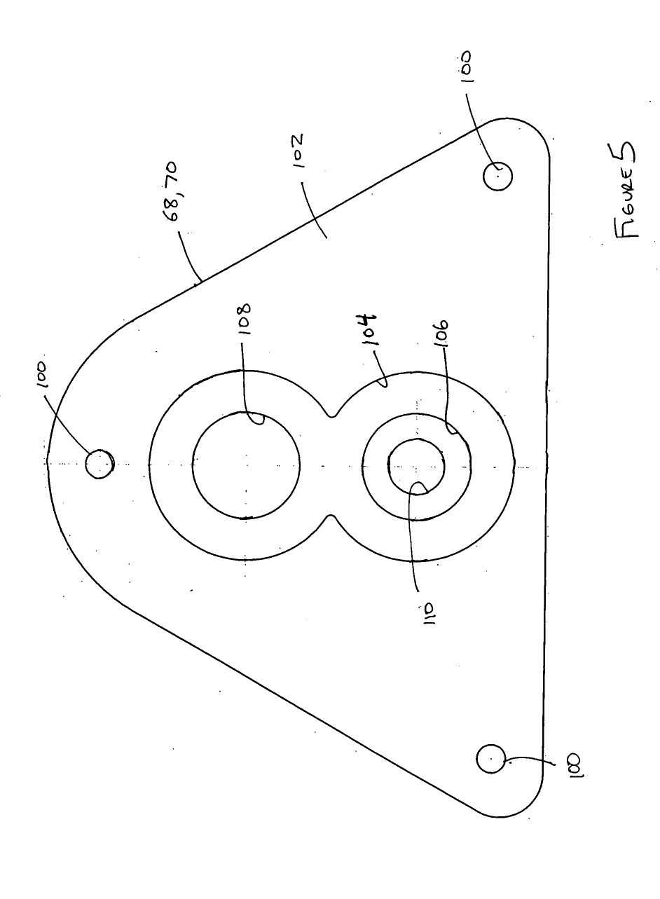

In the illustrated arrangement, the housing 12 includes an outer shell 60, including a pair of shell halves 62, 64 (FIG. 4). The housing 12 additionally includes a pair of frame members 68, 70 (shown individually in FIG. 5). Preferably, the shell halves 62, 64 generally enclose the frame member 68, 70, rollers 24, 26, and drive wheels 20. Desirably, the frame members 68, 70 provide support to the upper and lower rollers 24, 26 and, in a preferred embodiment, are constructed from a material having higher strength characteristics than the outer shell 60.

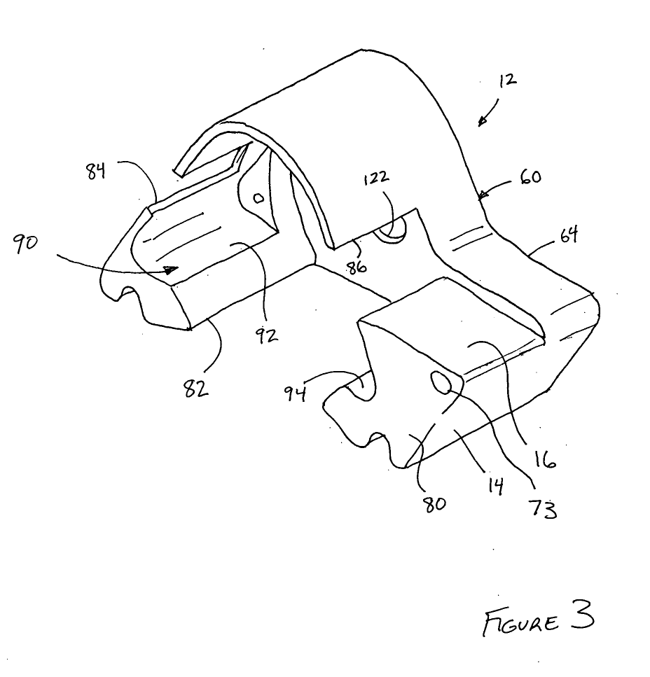

In the illustrated die cutting machine 10, the frame members 68, 70 are spaced apart by one or more spacer rods 72. In addition, a spacer rod 72 may be provided within an aperture 73 (FIG. 3) defined by the platform supporting portion 14 of the housing 12 to interconnect the shell halves 62, 64 at a forward location. Preferably, the shell halves 62, 64, frame members 68, 70, and spacer rods 72 are coupled to one another by a plurality of fasteners, such as threaded bolts 74, for example. In such an arrangement, the spacer rods 72 desirably include internal threads configured to mate with external threads of the bolts 74. However, other suitable means for interconnecting the shell 60, frame members 68, 70, and the spacer rods 72 may also be utilized. In addition, the housing 12 may take on a variety of shapes and sizes, and be constructed of a variety of materials, sufficient to support the upper and lower rollers, 24, 26 and the drive wheels 20.

With reference to FIG. 3, the shell halve 64 is shown separated from the die cutting machine 10. The shell halve 64 includes a mating surface 80 configured to contact a mating surface (not shown) of the shell halve 62. Preferably, the shell halve 62 is substantially similar to the shell halve 64, but is a mirror image thereof. Thus, the description herein of the shell halve 64 may be considered to equally apply to the shell halve 62, unless otherwise indicated.

Desirably, the shell halve 64 includes an opening 82 within its lower wall to permit a portion of the drive wheels 20 to pass therethrough. Desirably, the opening 82 is generally disposed in a central portion of the lower wall of the shell halve 64 and extends generally the entire width of the shell halve 64. However, other suitable arrangements may be used to permit a portion of the drive wheels 20 to extend from the shell 60. Similarly, the shell halve 62 preferably also includes an opening (not shown) to permit passage of a portion of the drive wheel 20.

The illustrated shell halve 64 also includes an entry opening 84 and an exit opening 86. Desirably, the entry opening 84 and the exit opening 86 are generally aligned with one another and the feed space 28 between the upper and lower rollers 24, 26. The entry and exit openings 84, 86 are sized to permit a die assembly to pass therethrough and, preferably, are at least as large, if not larger, than the feed space 28.

As described above, preferably, the housing 12 defines a platform 16 adjacent the exit opening 86 to receive and support the die assembly as it exits the feed space 28. However, in some arrangements, the platform 16 may be omitted as unnecessary or undesirable. Furthermore, a portion of the entry and exit openings 84, 86 are defined by the shell halve 62, as will be appreciated by one of skill in the art.

Desirably, the shell halve 64 defines a generally triangular-shaped interior space 90 including a pair of lower support surfaces 92, 94. The space 90 and support surfaces 92, 94 are configured to accommodate and, preferably, provide support to the frame member 70. Desirably, the shell halve 62 also includes a triangular-shaped space and support surfaces to accommodate and support the frame member 68 in a manner similar to that of shell halve 64.

With reference to FIG. 5, a preferred frame member 68 or 70, is illustrated as an individual component separate from the die cutting machine 10. Preferably, the frame members 68, 70 are generally triangular in shape and generally similar to one another, except as noted herein. The illustrated frame member 68, 70 includes three apertures 100 at the corners of the triangular-shaped to accommodate the fasteners 74.

An inner surface 102 of the illustrated frame member 68, 70 includes a recess 104 that is generally of a “Figure 8” shape. The recess 104 is configured to accommodate the gears 46a, 50a of the lower roller 26 or the gears 46b, 50b of the upper roller 24, depending on which end of the rollers 24, 26 that the frame member 68, 70 is positioned.

The lower circular portion of the recess 104 includes an additional recess 106 configured to accommodate and support the bearing 36a or 36b. The upper circular portion of the recess 104 includes an additional recess 108 configured to accommodate the bearing 42a or 42b. Desirably, the recess 106 further includes a circular aperture 110 extending through the frame member 70 for a purpose described in greater detail below.

In the illustrated arrangement, the drive wheels 20 include a drive member 112 configured to increase friction with the surface S. In the illustrated arrangement, the members 112 are annular, rubber members received within a groove 114 formed within an outer periphery of the drive wheels 20. Preferably, the members 112 have a higher coefficient of friction than the material of the body of the drive wheels 20. Accordingly, the drive members 112 facilitate rotation of the drive wheels 20 as the die cutting machine 10 is moved along the surface S.

Alternatively, other suitable arrangements may be employed to facilitate rotation of the drive wheels 20. For example, but without limitation, the entire drive wheels 20 may be constructed from a material having a suitable coefficient of friction. Furthermore, other types of surface features or distinct members may be used in connection with the drive wheels 20 to provide a desired grip on the surface S on which the die cutting machine 10 is likely to be used.

In operation, the die cutting machine 10 is placed on the surface S and a die assembly, including the workpiece (material to be cut, embossed, or otherwise processed), is assembled as known in the art. For example, the die assembly may incorporate a base plate, a die, one or more workpieces, and a cover plate. In some arrangements, the base plate may be omitted and the die itself may function as a base plate. Possibly, one or more shims may be included in the die assembly to achieve a desired thickness. Other types of die assemblies, or other compression activated assemblies, may also be used.

As the die cutting machine 10 is moved along the surface S, rotational motion is imparted to the drive wheels 20. Rotation of the drive wheels 20 rotates the lower roller 26 which, in turn, rotates the upper roller 24 as a result of the upper and lower rollers 24, 26 being coupled by the transmission mechanism 44. As the die machine 10 is moved along the surface S in the forward direction (as denoted by the arrow F in FIG. 1), the die assembly is introduced into the feed space 28 through the entry opening 84 of the housing 12. The rotation of the rollers 24, 26 conveys the die assembly through the feed space 28, thereby compressing the die assembly and cutting (or embossing) the workpiece. The die assembly exits the feed space 28 through the exit opening 86 and is delivered to the platform 16. The die assembly may then be disassembled to retrieve the cut (or embossed) workpiece(s).

As described above, variations on the described die cutting machine 10 may be employed. For example, the upper roller 24 may be an idler roller, which is not driven by rotation of the lower roller 26. As a result, a less expensive die cutting machine is made possible. Furthermore, a modification of the illustrated die cutting machine 10 is possible in which rotation of the drive wheels 20 is configured to result in translation of the rollers 24, 26 relative to the housing 12 to pass over a die assembly, which is held stationary relative to the housing 12, as will be appreciated by one of skill in the art.

Furthermore, in addition to, or in the alternative of, the drive wheels 20, the die cutting machine 10 may include a manual means for causing rotation of the drive wheels 20 and, thus, the lower roller 26. With reference to FIG. 4, a handle 120 can extend from the shaft portion 34b of the lower roller 26 through the aperture 110 of the frame member 70 and through an aperture 122 (FIG. 3) of the shell halve 64. The handle 120 permits a user of the die cutting machine 10 to rotate the lower roller 26 and thereby convey a die assembly through the feed space 28 without requiring the die cutting machine 10 to be rolled along the surface S. Such an arrangement is beneficial when no surface S of sufficient flatness or length is available.

Alternatively, the handle 120 may be similarly coupled to the upper roller 24. In the illustrated arrangement, rotation of one roller 24 or 26 with the handle 120 results in rotation of the other roller 24 or 26 via the gear assembly 46, 50. In addition, the handle 120 may be removable and coupled to the roller 26 only when desired. As will be appreciated by one of skill in the art, the handle 120 may take on different forms than that illustrated in FIG. 4 while maintaining the intended function.

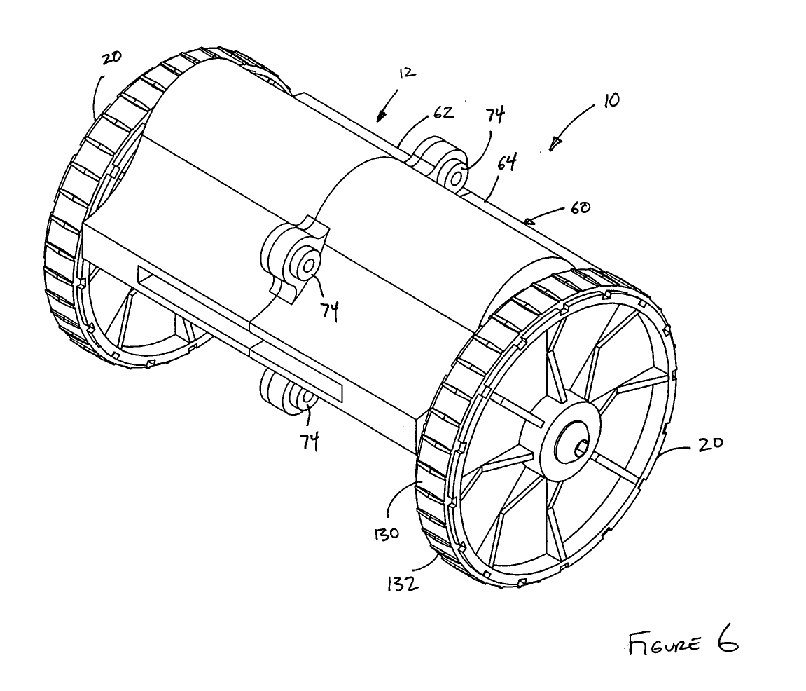

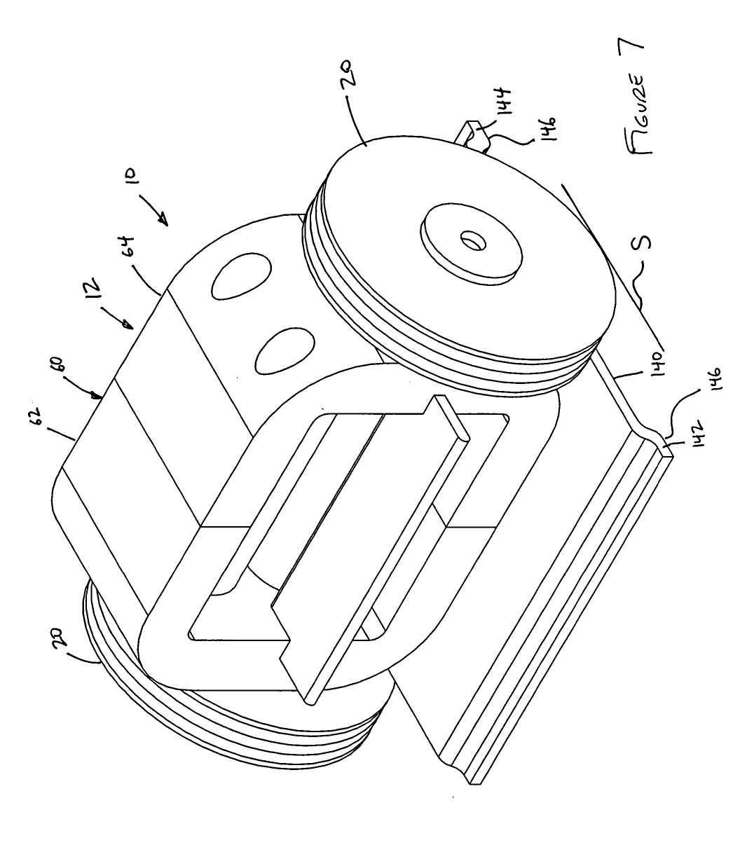

The die cutting machine 10 may take on any number of alternative shapes and sizes. FIGS. 6 and 7 illustrate modifications of the die cutting machine 10 of FIGS. 1-5. Accordingly, the same reference numerals are used to indicate the same or similar components in the die cutting machines of FIGS. 6 and 7. In addition, preferably, the internal components of the die cutting machines 10 of the FIGS. 6 and 7 are substantially similar to those described above, including any alternative arrangements described or suggested.

With reference to FIG. 6, the die cutting machine 10 includes a housing 12 having a shell 60. The shell includes two shell halves 62 and 64 coupled by fastener 74. In the die cutting machine 10 of FIG. 6, the drive wheels 20 are external of the shell 60. In addition, the drive wheels 20 include a treaded surface configuration 130 configured to provide a desired grip on a surface S on which the die cutting machine 10 is operated. The treaded surface 130 is defined by a plurality of axially oriented grooves 132.

With reference to FIG. 7, the illustrated die cutting machine 10 also includes drive wheels 20 that are external of the housing 12. The housing 12 includes a shell 60 having relatively simple C shaped shell halves 62, 64. In one arrangement, the shell halves 62, 64 may be constructed of metal and, thereby, also function as the frame members 68, 70 of the die cutting machine 10 of FIGS. 1-5.

The die cutting machine 10 of FIG. 7 additionally includes a plate 140 coupled to a lower wall of the shell 60. Forward and rearward ends 142, 144 of the plate 140 are stepped to a relatively lower height than an intermediate portion of the plate 140. Underneath sides of the forward and rearward portions 142, 144 define sliding contact surfaces 146 that are configured to slide along the surface S on which the die cutting machine 10 is operated in a manner similar to the idler wheels 22 of the die cutting machine 10 of FIGS. 1-5. Accordingly, preferably, the sliding surface 146 of only one of the forward and rearward portions 142, 144 are configured to contact the surface S along with the drive wheels 20 at a time.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalence thereof. In particular, while the present die cutting machine has been described in the context of particularly preferred embodiments, the skilled artisan will appreciate, in view of the present disclosure, that certain advantages, features and aspects of the die cutting machine and method may be realized in a variety of other applications, many of which have been noted above. Additionally, it is contemplated that various aspects and features of the invention described can be practiced separately, combined together, or substituted for one another, and that a variety of combination and subcombinations of the features and aspects can be made and still fall within the scope of the invention. Thus, it is intended that the scope of the present invention herein disclosed should not be limited by the particular disclosed embodiments described above, but should be determined only by fair reading of the claims.

1. A die cutting device, comprising:
a housing;
a pair of frame members supported within said housing in a spaced-apart orientation;
a first roller rotatably supported at opposing end portions by said pair of frame members;
at least one drive wheel coupled to said first roller, said drive wheel including a portion exposed from said housing such that said at least one drive wheel is capable of rolling along a surface to thereby rotate said first roller;
a second roller spaced from said first roller to define a feed space with said first roller, said feed space configured to accommodate a die assembly;
a transmission mechanism configured to rotate said second roller in response to rotation of said first roller.

2. The device of claim 1, additionally comprising a hand crank mechanism configured to permit a user of said device to rotate said first roller without rolling said device along said surface.

3. The device of claim 1, wherein said transmission mechanism comprises a gear set drive.

4. The device of claim 1, wherein said at least one drive wheel comprises a first drive wheel and a second drive wheel coupled to opposite end portions of said first roller.

5. The device of claim 1, additionally comprising at least one idler wheel supported by said housing and configured to be capable of contacting said surface along with said drive wheel to support said device on said surface.

6. The device of claim 5, wherein said at least one idler wheel comprises a first idler wheel and a second idler wheel, said first and second idler wheels positioned on opposing sides of said exposed portion of said drive wheel.

7. The device of claim 1, additionally comprising a first opening in said housing positioned on a first end of said feed space and a second opening in said housing positioned on a second end of said feed space opposite said first end.

8. The device of claim 7, wherein said housing defines a platform extending from one of said first and second opening.

9. A die cutting device, comprising:
a body;
a first roller supported for rotation relative to said body;
a second roller supported for rotation relative to said body at a position spaced from said first roller, said first and second rollers defining a feed space sized to accommodate a die assembly;
wherein said device is configured to be supportable on a surface and movable along said surface, and wherein said first roller is configured to rotate in response to movement of said device along said surface.

10. The device of claim 9, additionally comprising a hand crank mechanism configured to permit a user of said device to rotate said first roller without moving said device along said surface.

11. The device of claim 9, additionally comprising a transmission mechanism configured to rotate said second roller in response to rotation of said first roller.

12. The device of claim 9, additionally comprising at least one drive wheel connected to said first roller, said at least one drive wheel configured to contact said surface and rotate in response to movement of said device along said surface and thereby rotate said first roller.

13. The device of claim 12, wherein said drive wheel directly drives said first roller.

14. The device of claim 12, wherein said at least one drive wheel comprises a first drive wheel and a second drive wheel spaced from one another along an axis of said first roller.

15. The device of claim 9, wherein said body defines a platform configured to support said die assembly substantially in alignment with said feed space.

16. The device of claim 9, wherein said body comprises a housing and a pair of frame members, said frame members configured to rotatably support opposing end portions of said first and second rollers.

17. A die cutting device, comprising:
a first compression surface;
a second compression surface spaced from said first compression surface, said first and second compression surfaces defining a feed space sized to accommodate a die assembly; and
means for moving a die assembly through said feed space in response to movement of said device along a surface.

18. The device of claim 17, additionally comprising means for permitting a user to move said die assembly through said feed space without movement of said device along a surface.

19. The device of claim 17, wherein said first compression surface is defined by a first roller.

20. The device of claim 19, wherein said second compression surface is defined by a second roller.

21. A method of die cutting, comprising;
rotating a first roller by moving a die cutting device along a surface;
feeding a die assembly through a feed space defined between said first roller and a second roller; and
compressing said die assembly between said first and second rollers.

22. The method of claim 21, additionally comprising the step of rotating said second roller by utilizing said rotation of said first roller.

23. The method of claim 21, providing a mechanical advantage to said rotation of said first roller by utilizing a drive wheel contacting said surface to drive said first roller, said drive wheel having a diameter that is larger than a diameter of said first roller.
